(19) United States
(12) Patent Application Publication
(10) Pub. No.: US 2008/0241534 A1
(43) Pub. Date: Oct. 2, 2008

(54) FLUORINE-CONTAINING RESIN FOR ELECTRIC WIRE JACKET AND ELECTRIC WIRE JACKET PRODUCED FROM SAME

(75) Inventors: Katsuhide Ohtani, Settsu-shi (JP); Tsuyoshi Ono, Settsu-shi (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES, LTD., Osaka-shi (JP)

(21) Appl. No.: 12/058,479

(22) Filed: Mar. 28, 2008

Related U.S. Application Data
(60) Provisional application No. 60/907,350, filed on Mar. 29, 2007.

(51) Int. Cl. C08F 14/26; B32B 27/00; C08F 16/24

(52) U.S. Cl. 428/375; 526/247; 526/254

(57) ABSTRACT

The present invention provides a fluorine-containing resin being excellent in mold-processability and providing an electric wire jacket having excellent flame retardance, low smoke releasing property, flexibility and mechanical properties. The fluorine-containing resin is a resin for an electric wire jacket substantially comprising, as a resin component, only a fluorine-containing copolymer having a MFR of 11 to 27 g/10 min and comprising tetrafluoroethylene and a perfluoro ethylenically unsaturated compound represented by the formula: CF₂═CF—R_{f}¹, wherein R_{f}¹ represents —CF₃ and/or —OR_{f}²; R_{f}² represents a perfluoroalkyl group having 1 to 5 carbon atoms. The present invention also provides an electric wire jacket.

### CROSS-REFERENCE TO RELATED APPLICATIONS

This application claims benefit under 35 U.S.C. §119(e) of U.S. Provisional Application No. 60/907,350 filed on Mar. 29, 2007, incorporated herein by reference in its entirety.

### BACKGROUND OF THE INVENTION

The present invention relates to a fluorine-containing resin being excellent in mold-processability and providing an electric wire jacket having excellent flame retardance, low smoke releasing property, flexibility and mechanical properties, an electric wire jacket made of the resin, and a cable having the electric wire jacket.

Since flame propagation caused by an electric wire, which runs on a ceiling and a plenum part under a floor, a cable coating material and the like recently has been a problem, particularly excellent heat resistance and flame retardance (resistance to flame propagation and low smoke releasing property) are required for an electric wire jacket in addition to mold-processability and flexibility. As a material for such an electric wire jacket, fluorine-containing resins excellent in properties such as sliding property, heat resistance, chemical resistance, weather resistance and electrical properties are used.

Further, since LCC (Limited Combustible Cable) requires higher flame retardance than a plenum cable, development of a material having mold-processability, flexibility and mechanical properties and further having excellent heat resistance and flame retardance is desired for a jacket of LCC.

For example, a tetrafluoroethylene-hexafluoropropylene copolymer (FEP) is known as a material for an electric wire jacket such as a jacket for LCC (USP 2005/0173674 and USP 2005/0187328).

Meanwhile, with respect to flame retardance of an electric wire jacket, in the combustion test of NFPA255 (Surface Burning Characteristics of Building Materials), an electric wire jacket is required to pass a Flame Spread Test (flame spread index FSI is 25 at maximum) and a Smoke Developed Test (smoke developed index SDI is 50 at maximum). It has been considered that FEP passing NFPA255 tests is one having a low MFR (melt flow rate, ASTM D-1238), namely, one having a low melt-flowability because melting and dropping hardly occur at burning, thus hardly causing flame propagation and smoke development, and a smoke developed index is low. For example, USP 2005/0173674 mentions that the smoke developed index of FEP having MFR (372° C.) of more than 10 g/10 min exceeds 50, and further USP 2005/0187328 mentions that the smoke developed index of FEP having MFR (372° C.) of more than 7 g/10 min exceeds 50.

On the other hand, while mold-processability (line speed for melt-extruding an electric wire) is excellent when MFR is larger, it is disclosed that when FEP having MFR of 2 to 7 g/10 min is used alone as a coating material, a line speed is about 30.5 m/min (100 ft/min) and when a hydrocarbon polymer exists, a line speed can be increased to 91.1 m/min (300 ft/min) or more.

As mentioned above, an electric wire jacket prepared by using FEP having a low MFR is excellent in low smoke releasing property, but there is a problem that its mold-processability is inferior.

### SUMMARY OF THE INVENTION

The present invention provides a fluorine-containing resin for an electric wire jacket which is excellent in heat resistance and flame retardance and has satisfactory mold-processability.

Namely, the present invention relates to a resin for an electric wire jacket substantially comprising, as a resin component, only a fluorine-containing copolymer having a MFR (372° C., hereinafter the same) of 11 to 27 g/10 min and comprising tetrafluoroethylene and a perfluoro ethylenically unsaturated compound represented by the formula (1):

CF₂═CF—R_{f}¹ (1)

wherein R_{f}¹ represents —CF₃ and/or —OR_{f}²; R_{f}² represents a perfluoroalkyl group having 1 to 5 carbon atoms.

It is preferable from the viewpoint of satisfactory mold-processability that the above-mentioned fluorine-containing copolymer is one comprising 77 to 95% by mole of a tetrafluoroethylene unit and 5 to 23% by mole of a unit of the above-mentioned perfluoro ethylenically unsaturated compound.

In addition, the present invention relates to an electric wire jacket formed by using the above-mentioned resin.

Further the present invention relates to a cable having the mentioned electric wire jacket.

### DETAILED DESCRIPTION

The present invention relates to the resin for an electric wire jacket substantially comprising, as a resin component, only a fluorine-containing copolymer (a) having a MFR of 11 to 27 g/10 min and comprising tetrafluoroethylene and the perfluoro ethylenically unsaturated compound represented by the formula (1):

CF₂═CF—R_{f}¹ (1)

wherein R_{f}¹ represents —CF₃ and/or —OR_{f}²; R_{f}² represents a perfluoroalkyl group having 1 to 5 carbon atoms.

Examples of the perfluoro ethylenically unsaturated compound constituting the fluorine-containing ethylenic polymer (a) and represented by the formula (1):

CF₂═CF—R_{f}¹ (1)

wherein R_{f}¹ represents —CF₃ and/or —OR_{f}²; R_{f}² represents a perfluoroalkyl group having 1 to 5 carbon atoms, are hexafluoropropylene (HFP) and perfluoro(alkyl vinyl ether) (CF₂═CF—OR_{f}², PAVE). Examples of PAVE are perfluoro(methyl vinyl ether), perfluoro(ethyl vinyl ether), perfluoro(propyl vinyl ether) and the like.

Examples of the fluorine-containing ethylenic polymer (a) are a TFE/HFP copolymer, a TFE/CF₂═CF—OR_{f}² copolymer, a TFE/HFP/CF₂═CF—OR_{f}² copolymer and the like.

Among them, preferable is the TFE/HFP/CF₂═CF—OR_{f}² copolymer, more preferable is the fluorine-containing ethylenic polymer (a) comprising 77 to 95% by mole of a TFE unit, 5 to 20% by mole of a HFP unit and 0.1 to 3% by mole of a —CF₂═CF—OR_{f}² unit, further preferable is the fluorine-containing ethylenic polymer (a) comprising 90 to 93% by mole of a TFE unit, 7 to 10% by mole of a HFP unit and 0.3 to 1% by mole of a —CF₂═CF—OR_{f}² unit, in that it is excellent in stress crack resistance and is advantageous from economical point of view.

In addition, the fluorine-containing ethylenic polymer (a) comprising TFE and the perfluoro ethylenically unsaturated compound represented by the formula (1) may contain other third components.

Examples of the third component (unit) of the fluorine-containing ethylenic polymer (a) are non-perfluoroolefins and/or non-fluorine-containing ethylenically unsaturated compounds which are copolymerizable with the above-mentioned TFE and perfluoro ethylenically unsaturated compound. A copolymerization ratio of these third components is preferably 0 to 7% by mass, further preferably 0 to 5% by mass.

Examples of the non-perfluoroolefins are, for instance, 2,3,3,4,4,5,5-heptafluoro-1-pentene (CH₂═CFCF₂CF₂CF₂H) and the like.

Examples of the non-fluorine-containing ethylenically unsaturated compounds are, for instance, ethylene, propylene, alkyl vinyl ethers and the like. Here alkyl vinyl ethers are those having an alkyl group having 1 to 5 carbon atoms.

With respect to the third component of the fluorine-containing ethylenic polymer (a), it is preferable not to use a component being capable of introducing a functional group (for example, a carboxyl group, a haloformyl group, a carbinol group, a carboxylic acid amide group and the like) if possible in that the copolymer is hardly decomposed by heating at melt-molding and also foaming in a molded article can be inhibited. For the same reason as above, it is desirable that an end group of the copolymer (a) is not an unstable end group (for example, a carboxyl group, a haloformyl group, a carbinol group, a carboxylic acid amide group and the like), and it is preferable that the number of unstable end groups is not more than 50 per 1,000,000 carbon atoms. From this point of view, it is preferable to prepare the fluorine-containing copolymer (a), for example, by a suspension polymerization method using a fluorine-containing diacyl peroxide polymerization initiator such as [H(CF₂CF₂)₃COO—]₂ (DHP) or (CF₃CF₂COO—)₂.

A MFR of the fluorine-containing ethylenic polymer (a) constituting the fluorine-containing resin of the present invention is not less than 11 g/10 min and not more than 27 g/10 min.

As mentioned above, heretofore it has been considered that a fluorine-containing ethylenic polymer having MFR of more than 10 g/10 min does not pass NFPA255 and yet has poor mold-processability. However when the MFR of a polymer is within a range of not less than 11 g/10 min and not more than 27 g/10 min, unexpectedly mold-processability is satisfactory and the polymer passes NFPA255 though the reason for that is unknown. A preferable MFR is not less than 17 g/10 min, further not less than 21 g/10 min from the viewpoint of more satisfactory mold-processability, and is not more than 26 g/10 min, further not more than 25 g/10 min from the viewpoint of more satisfactory mechanical properties. The MFR of the fluorine-containing copolymer (a) can be adjusted by a molecular weight of the polymer. Namely, the MFR can be adjusted by the amounts of a polymerization initiator and a chain transfer agent.

A melting point of the fluorine-containing copolymer (a) used in the present invention is preferably 120° to 310° C., more preferably 150° to 290° C., further preferably 170° to 270° C. in that mold-processing of the fluorine-containing resin becomes easier. When the melting point of the fluorine-containing copolymer (a) is less than 120° C., heat resistance of the obtained fluorine-containing resin tends to be lowered, and when the melting point exceeds 310° C., melt-moldability tends to be lowered. The melting point can be set by a copolymerization ratio of TFE to the perfluoro ethylenically unsaturated compound represented by the aforementioned formula (1).

In addition, to the fluorine-containing resin of the present invention can be added additives usually used for electric wire jackets such as a pigment, lubricant, photostabilizer, weather resistance stabilizer, antistatic agent, ultraviolet absorber, antioxidant, mold releasing agent, foaming agent, perfume, oil and softening agent to such an extent not to impair the effect of the present invention.

The electric wire jacket aimed at by the present invention is one generally used for imparting flame retardance and preventing mechanical damages of wires and cables for electronic devices of a computer, etc., and is a tube-like article housing a copper wire and its covering material. A method of molding the jacket is not limited particularly, and examples thereof are, for instance, known methods such as a method of extrusion molding with a crosshead and a single screw extruder.

The electric wire jacket is one comprising the above-mentioned components, and therefore has satisfactory moldability, flexibility and electrical properties, exhibits especially excellent heat resistance, and can be used suitably as a jacket for LCC (Limited Combustible Cable) requiring higher flame retardance than that of conventional jackets. A thickness of the electric wire jacket of the present invention can be optionally set depending on applications, and usually the jacket has a thickness of 0.2 to 1.0 mm. The electric wire jacket of the present invention has a thickness within the above-mentioned range, and therefore is excellent especially in flexibility.

The electric wire jacket of the present invention is obtained by molding the fluorine-containing resin of the present invention and is excellent in flame retardance, flexibility and electrical properties.

Application of the electric wire jacket of the present invention is not limited particularly, and it can be used, for example, for an electric wire for wiring of electronic devices, 600 V insulated electric wire for electric devices, communication cables such as LAN cable, etc. The LAN cable means a cable used for LAN.

The cable which is featured by having the electric wire jacket of the present invention and used for LAN is also one of the present inventions. Examples of the cable used for LAN are plenum cable and the like, and the cable is suitably used for the aforementioned LCC.

In the cable of the present invention, a jacket thickness can be optionally set, and the jacket is molded usually in a thickness of 0.2 to 1.0 mm. The cable of the present invention used for LAN is provided with the electric wire jacket of the present invention, and therefore is excellent in flame retardance, flexibility and electrical properties.

### EXAMPLES

The present invention is then explained by means of Examples, but is not limited to them.

Measuring methods and evaluation methods used in the present invention are explained below.

### <MFR>

MFR is measured at a load of 5 kg at a measuring temperature of 372° C. according to ASTM D-1238.

### <Number of Unstable End Groups>

The number of unstable end groups is measured according to the methods described in JP37-3127B and WO 99/45044.

### <Flame Retardance Test>

Measuring is carried out according to NFPA255. Measuring conditions stipulated in NFPA255 are a cable length of 7.6 m and a test period of time of 10 minutes. In the case of a LCC cable, criteria for passing the test are stipulated in UL2424 standard. A flame spread index (FSI) is 25 at maximum, and a smoke developed index (SDI) is 50 at maximum.

<Fluorine-Containing Ethylenic Polymer (a-1)>

TFE/HFP/perfluoro(propyl vinyl ether) copolymer prepared by a suspension polymerization method using DHP as a polymerization initiator (molar ratio=91.9/7.7/0.4; MFR of 24.3 g/10 min; melting point of 260° C.; the number of unstable end groups 0 per 1,000,000 carbon atoms)

<Fluorine-Containing Ethylenic Polymer (a-2)>

TFE/HFP copolymer (molar ratio=92.5/7.5; MFR of 3.1 g/10 min; melting point of 268° C.; the number of unstable end groups=3 per 1,000,000 carbon atoms)

### Example 1

Cat. 6 4-pair UTP cable was produced by using pellets of the fluorine-containing ethylenic polymer (a-1) as a material for a jacket. The same fluorine-containing ethylenic polymer (a-1) was used as a resin for an insulating covering material of a primary copper wire and a cross web. For molding of the jacket, a 30 mm diameter single screw extruder of L/D=22, a die having an inner diameter of 15.0 mm and a tip having an outer diameter of 13.2 mm were used. A temperature profile of the extruder was C-1: 270° C., C-2: 290° C., C-3: 300° C., flange: 300° C., head: 300° C., and die: 300° C., a screw rotational number was 10 rpm, and a line speed was 5 m/min. The fluorine-containing resin was coated as a jacket on the 4-pair cable with a cross web, and a cable having a jacket thickness of 0.32 mm and a cable outer diameter of 4.72 mm was obtained. In molding this jacket, DDR (Draw Down Ratio) was 9.

A flame retardance test was carried out by using the obtained cable. Flame Spread Index (FSI; in the case of LCC, FSI is 25 at maximum for passing the test) indicating flame propagation of the cable was 0, and Smoke Developed Index (SDI; in the case of LCC, SDI is 50 at maximum for passing the test) indicating smoke generation from the cable was 5. Accordingly, it is obvious that the cable of the present invention satisfies the requirements of UL2424 standard, and can be used as LCC.

### Comparative Example 1

Cat. 6 4-pair UTP cable was produced in the same manner as in Example 1 by using pellets of the fluorine-containing ethylenic polymer (a-2) as a material for a jacket.

When the screw rotational number was the same (10 rpm) as in Example 1, a melt fracture occurred and a surface skin became rough. Therefore coating of a jacket was carried out at a line speed of 2.5 m/min by decreasing the screw rotational number to 5 rpm.

A flame retardance test was carried out by using the obtained cable. Flame Spread Index (FSI) indicating flame propagation of the cable was 0, and Smoke Developed Index (SDI) indicating smoke generation from the cable was 15. The cable satisfies the requirements of UL2424 standard, and can be used as LCC. However unexpectedly Smoke Developed Index is higher than that of Example 1 in which MFR is larger.

The present invention can provide a fluorine-containing resin being excellent in mold-processability and providing an electric wire jacket having excellent flame retardance, low smoke releasing property, flexibility and mechanical properties, an electric wire jacket prepared by using the resin, and a cable having the electric wire jacket.

What is claimed is:

1. A fluorine-containing resin for an electric wire jacket substantially comprising, as a resin component, only a fluorine-containing copolymer having a MFR (372° C.) of 11 to 27 g/10 min and comprising tetrafluoroethylene and a perfluoro ethylenically unsaturated compound represented by the formula (1):
CF₂═CF—R_{f}¹ (1)
wherein R_{f}¹ represents —CF₃ and/or —OR_{f}²; R_{f}² represents a perfluoroalkyl group having 1 to 5 carbon atoms.

2. The fluorine-containing resin of claim 1, wherein said fluorine-containing copolymer is a copolymer comprising 77 to 95% by mole of a tetrafluoroethylene unit and 5 to 23% by mole of a unit of said perfluoro ethylenically unsaturated compound.

3. An electric wire jacket formed by using the fluorine-containing resin of claim 1.

4. An electric wire jacket formed by using the fluorine-containing resin of claim 2.

5. A cable having the electric wire jacket of claim 3.

6. A cable having the electric wire jacket of claim 4.
